(19) United States
(12) Patent Application Publication
(10) Pub. No.: US 2016/0164374 A1
(43) Pub. Date: Jun. 9, 2016

(54) ROTOR OF WOUND ROTOR DRIVING MOTOR

(71) Applicant: Hyundai Motor Company, Seoul (KR)

(72) Inventors: Hong Seok Yang, Suwon (KR); Sangjin Park, Hwaseong (KR); Jungwoo Lee, Hwaseong (KR)

(21) Appl. No.: 14/747,503

(22) Filed: Jun. 23, 2015

(30) Foreign Application Priority Data
Dec. 3, 2014 (KR) 10-2014-0172127

(51) Int. Cl. H02K 9/02; H02K 3/38; H02K 3/487

(52) U.S. Cl. CPC H02K 9/02; H02K 3/487; H02K 3/38

(57) ABSTRACT

A rotor of a wound rotor driving motor includes: a rotor body that is rotatably installed at a predetermined air gap at an inside of a stator and in which a rotor coil is wound in a plurality of rotor teeth; and an end coil cover that is mounted at each of both sides of an axial direction of the rotor body in order to prevent the rotor coil from separating, where the rotor body forms a plurality of air movement passages that are open to the outside in an axial direction, and the end coil cover forms a plurality of connection passages that are connected to the air movement passage.

### CROSS-REFERENCE TO RELATED APPLICATION

This application claims under 35 U.S.C. §119(a) the benefit of Korean Patent Application No. 10-2014-0172127 filed in the Korean Intellectual Property Office on Dec. 3, 2014, the entire contents of which are incorporated herein by reference.

### BACKGROUND

(a) Technical Field

The present invention relates to a wound rotor driving motor, more particularly, to a rotor cooling structure of a wound rotor driving motor that can cool a rotor coil with external air as an open structure by utilizing a non-molding method.

(b) Description of the Related Art

In general, a hybrid vehicle or an electric vehicle may generate driving torque by an electric motor (hereinafter referred to as a “drive motor”) that obtains torque with electrical energy.

For example, a hybrid vehicle is configured to be driven in an Electric Vehicle (EV) mode, which is a pure electric vehicle mode using only power of a drive motor, or in a Hybrid Electric Vehicle (HEV) mode using torque of both an engine and a drive motor as power sources. Generally, an electric vehicle is driven using torque of a drive motor as a power source.

A drive motor that is used as a power source in an environmentally-friendly vehicle mostly uses a Permanent Magnet Synchronous Motor (PMSM). It is necessary for such a PMSM to maximize performance of a permanent magnet in order to exhibit maximum performance in a restricted layout condition.

In the permanent magnet, a neodymium (Nd) component enhances intensity of a permanent magnet, and a dysprosium (Dy) component enhances high temperature demagnetization tolerance. However, a rare earth (Nd, Dy) metal component of such a permanent magnet is limitedly buried in some countries such as China and is very expensive, and a price thereof is extremely volatile.

In order to avoid sourcing problems of permanent magnets, application of an induction motor has recently been considered, but in order to exhibit the same motor performance, it is necessary to increase the size such as a volume and a weight.

Development of a Wound Rotor Synchronous Motor (WRSM) that can replace a Permanent Magnet Synchronous Motor (PMSM) as a drive motor that is used as a power source of an environmentally-friendly vehicle has been attempted.

By forming a rotor in an electromagnet when applying a current by winding a coil in a rotor as well as a stator, the WRSM replaces a permanent magnet of the PMSM.

In such a WRSM, the rotor is disposed at a predetermined air gap at the inside of the stator, and when power is applied to a coil of the stator and the rotor, a magnetic field is formed, and the rotor rotates by a magnetic action occurring therebetween.

Because the WRSM winds a coil to a rotor, unlike in a PMSM, when the rotor rotates in a high speed (in a normal EV, a maximum of 10,000 rpm or more), the rotor coil may be separated by centrifugal force.

In order to prevent this, in the conventional art, as an example, an end coil cover is mounted in both end portions of a rotor, and by molding a resin within the end coil cover, a rotor coil is fixed.

Further, such a WRSM has a structure in which a rotor is disposed at a predetermined air gap at the inside of a stator and may thus generate a magnetic flux by applying a current to a rotor coil through a brush and a slip ring.

Accordingly, in a WRSM, copper loss occurs by resistance of a rotor coil, and this operates as a factor that deteriorates performance of a motor by causing a heat of the rotor coil.

The above information disclosed in this Background section is only for enhancement of understanding of the background of the invention and therefore it may contain information that does not form the prior art that is already known in this country to a person of ordinary skill in the art.

### SUMMARY

The present invention provides a rotor of a wound rotor driving motor having advantages of being capable of moving external air in an axial direction through an end coil cover as an open structure by utilizing a non-molding method and efficiently removing heat occurring in a rotor coil, thus cooling the rotor coil.

An exemplary embodiment of the present invention provides a rotor of a wound rotor driving motor including: a rotor body that is rotatably installed at a predetermined air gap at the inside of a stator and in which a rotor coil is wound in a plurality of rotor teeth; and an end coil cover that is mounted at each of both sides of an axial direction of the rotor body in order to prevent the rotor coil from separating.

The rotor body forms a plurality of air movement passages that are open to the outside in an axial direction therein.

The end coil cover forms a plurality of connection passages that are connected to the air movement passage.

The rotor body may be formed in an open structure by utilizing a non-molding method of connecting the end coil cover.

The air movement passage may be formed between rotor teeth in which the rotor coil is wound in the rotor body.

The end coil cover may include a plurality of ribs that radially partition the plurality of connection passages.

The ribs may be provided as a twist blade that is twisted in a pan shape.

The twist blade may have opposite twist directions at both sides of the axial direction of the rotor body.

The end coil cover may be coupled to each of both sides of the rotor body and be coupled to a wedge that supports the rotor coil between rotor teeth of the rotor body.

The end coil cover may integrally form a wedge fixing portion that is coupled to the wedge.

The end coil cover may include: a first support ring that supports external circumferences of both sides of the rotor body; a second support ring that supports a rotation shaft of a central portion of the rotor body; and ribs that integrally connect the first and second support rings and that radially partition the plurality of connection passages.

The ribs may be provided as a twist blade of a pan shape.

The twist blade may have a twist direction of an opposite direction at both sides of the axial direction of the rotor body.

The rotor body may include a wedge that is installed between rotor teeth and that supports the rotor coil.

A wedge fixing portion that is coupled to the wedge may be integrally formed at a support surface of the first support ring.

### BRIEF DESCRIPTION OF THE DRAWINGS

FIG. 1 is a coupled perspective view illustrating a rotor of a wound rotor driving motor according to an exemplary embodiment of the present invention.

FIG. 2 is a partially exploded perspective view illustrating the rotor of the wound rotor driving motor of FIG. 1.

FIG. 3 is a diagram illustrating a rotor body that is applied to the rotor of the wound rotor driving motor of FIG. 1.

FIG. 4 is a side cross-sectional view illustrating the rotor of the wound rotor driving motor of FIG. 1.

FIG. 5 is a perspective view illustrating an exemplary variation of an end coil cover that is applied to the rotor of the wound rotor driving motor of FIG. 1.

FIG. 6 is a partial cross-section view illustrating the exemplary variation of the end coil cover that is applied to the rotor of the wound rotor driving motor of FIG. 5.

FIG. 7 is a partially exploded perspective view illustrating a rotor of a wound rotor driving motor according to another exemplary embodiment of the present invention.

FIG. 8 is a side cross-sectional view illustrating the rotor of the wound rotor driving motor of FIG. 7.

FIG. 9 is a perspective view illustrating an exemplary variation of an end coil cover that is applied to the rotor of the wound rotor driving motor of FIG. 7.

FIG. 10 is a partially cross-section view illustrating an exemplary variation of an end coil cover that is applied to the rotor of the wound rotor driving motor of FIG. 7.

### DETAILED DESCRIPTION OF THE EMBODIMENTS

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

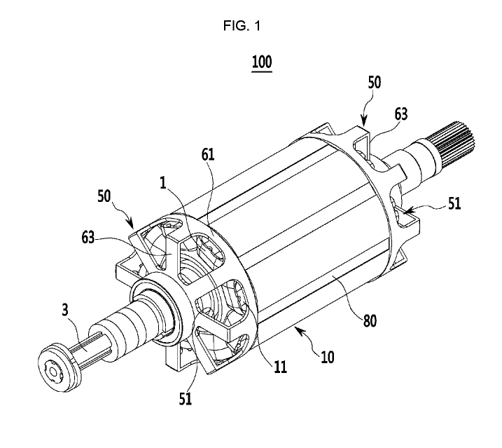

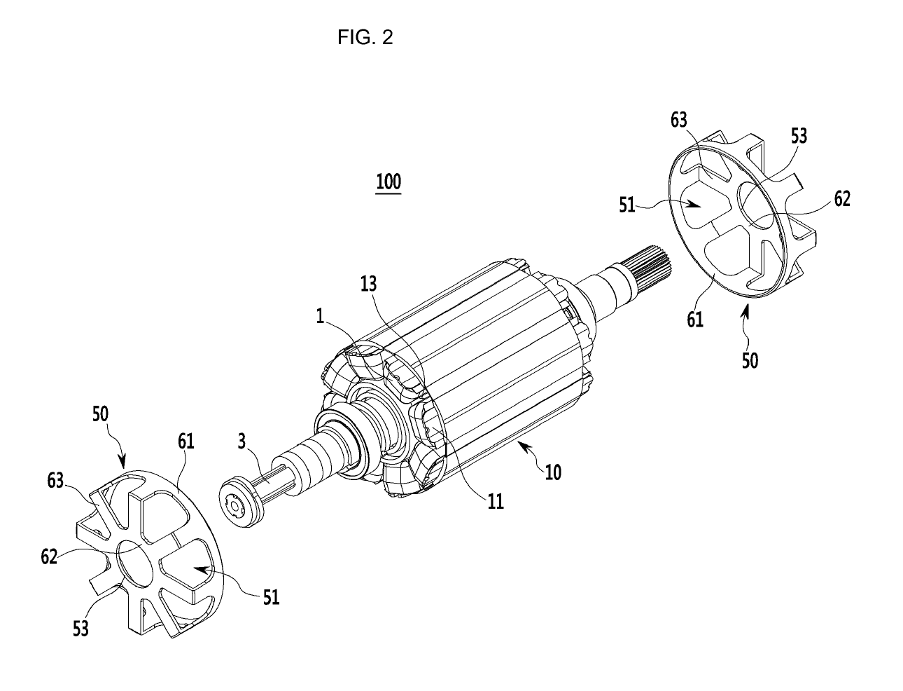

FIG. 1 is a coupled perspective view illustrating a rotor of a wound rotor driving motor according to an exemplary embodiment of the present invention, and FIG. 2 is a partially exploded perspective view illustrating the rotor of the wound rotor driving motor of FIG. 1.

Referring to FIGS. 1 and 2, an exemplary embodiment of the present invention is applied to a wound rotor driving motor, and the wound rotor driving motor may be applied to an electric motion apparatus that obtains driving torque with electrical energy in an environmentally friendly vehicle.

For example, the WRSM includes a stator (not shown) in which a stator coil (not shown) is wound, and a rotor 100 according to an exemplary embodiment of the present invention in which a rotor coil 1 is wound and that is disposed at the inside of the stator.

In the foregoing description, in the rotor 100, a rotation shaft 3 is coupled to the central side thereof, and an outer surface of the rotor 100 is disposed at the inside of the stator at a predetermined air gap from an interior diameter surface of the stator.

Therefore, the WRSM may form the rotor 100 in an electromagnet when applying a current by winding the rotor coil 1 in the rotor 100 as well as the stator and generate a driving torque with electromagnetic attraction and repulsive force between an electromagnet of the rotor 100 and an electromagnet of the stator.

The rotor 100 of the wound rotor driving motor according to an exemplary embodiment of the present invention has an open structure by utilizing a non-molding method and has a structure that moves external air in an axial direction and that can effectively remove heat that occurs in the rotor coil 1, thus cooling the rotor coil 1.

For this reason, the rotor 100 of the wound rotor driving motor according to an exemplary embodiment of the present invention includes a rotor body 10 and an end coil cover 50.

In an exemplary embodiment of the present invention, the rotor body 10 is rotatably installed at a predetermined air gap at the inside of the stator (not shown). The rotation shaft 3 is coupled in a central portion of the rotor body 10.

The rotor body 10 includes a plurality of rotor teeth 11 in which the rotor coil 1 is wound. The rotor teeth 11 are long formed in an axial direction and are separately disposed by a predetermined gap in a circumference direction (external circumference direction) of the rotor body 10.

Further, a slot 13 for winding the rotor coil 1 in the rotor teeth 11 is formed between the rotor teeth 11. In particular, the rotor teeth 11 are separately disposed by a predetermined gap in a circumference direction of the rotor body 10 with the slot interposed 13 therebetween.

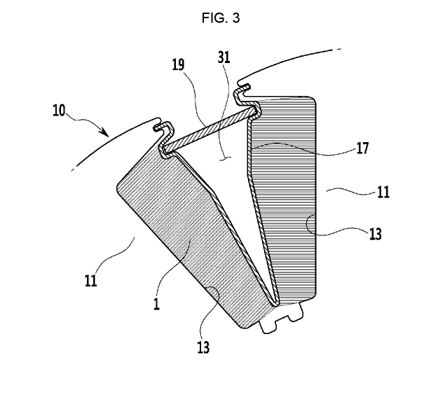

FIG. 3 is a diagram illustrating a rotor body that is applied to the rotor of the wound rotor driving motor of FIG. 1.

Referring to FIG. 3, in the rotor body 10 according to the exemplary embodiment of the present invention, a wedge 17 as a support structure for supporting the rotor coil 1 that is wound in the rotor teeth 11 is installed in the slot 13 between the rotor teeth 11.

When the rotor body 10 rotates at a high speed, the wedge 17 secures insulation between the rotor coil 1 that is wound in the rotor teeth 11 while supporting a centrifugal force operating in the rotor coil 1.

The wedge 17 is installed in an axial direction in the slot 13 between the rotor teeth 11. The wedge 17 is inserted in the axial direction into the slot 13 between the rotor teeth 11 and may be coupled to the rotor teeth 11 with a sliding method.

Further, the wedge 17 is made of an insulating material for insulation between the rotor coil 1 that is wound in the rotor teeth 11. The wedge 17 has a surface that supports the rotor coil 1 in the slot 13 between the rotor teeth 11 and forms a predetermined space in an axial direction to the inside.

At both end sides of the rotor body 10, a separate wedge plate 19 for fixing the wedge 17 in an axial direction is installed. The wedge plate 19 supports the rotor teeth 11 at both end sides of the rotor body 10, and may be insertion coupled to both end portions of the wedge 17.

Reference numeral 80 represents a rotor outer cover that encloses the external circumference side of the rotor body 10.

In an exemplary embodiment of the present invention, the rotor body 10 may be formed in an open structure by utilizing a non-molding method of connecting the end coil cover 50, to be described later.

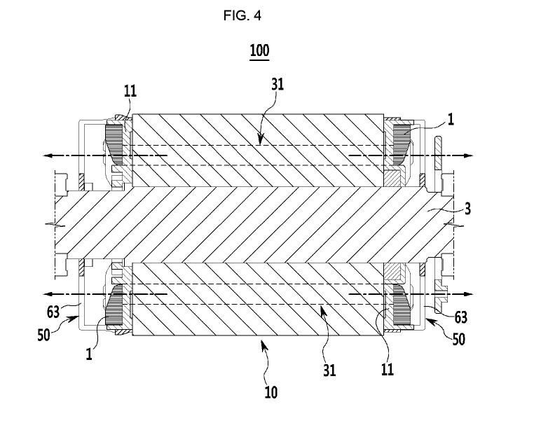

As shown in FIG. 4, such a rotor body 10 forms a plurality of air movement passages 31 for moving external air to the inside in an axial direction.

As shown in FIGS. 3 and 4, the air movement passage 31 is open to the outside in an axial direction of the rotor body 10, and may be formed between the rotor teeth 11 in which the rotor coil 1 is wound in the rotor body 10.

For example, the air movement passage 31 may be formed at an internal space of the wedge 17 that is installed in the slot 13 between the rotor teeth 11. In particular, the rotor body 10 may move external air along an internal space of the wedge 17 as the air movement passage 31.

Referring to FIGS. 1 and 2, in the exemplary embodiment of the present invention, when the rotor body 10 rotates at a high speed (in a normal EV, a maximum of 10,000 rpm or more), the end coil cover 50 prevents the rotor coil 1 from being separated from the rotor teeth 11 by centrifugal force.

The end coil cover 50 is mounted at each of both sides of an axial direction of the rotor body 10, and is inserted and fixedly coupled to end portions of both sides of the rotor body 10.

In the exemplary embodiment of the present invention, in order to move external air to the air movement passage 31 (see FIG. 4) of the rotor body 10, the end coil cover 50 forms a plurality of connection passages 51 that are connected to the air movement passage 31.

The end coil cover 50 is formed with a first portion that supports end portions of both sides of the rotor body 10 and a second portion that supports the rotation shaft 3, and in the second portion, an axial bore 53 to which the rotation shaft 3 is coupled is formed. The plurality of connection passages 51 are formed between the first portion and the second portion.

Specifically, the end coil cover 50 according to the exemplary embodiment of the present invention includes a first support ring 61 as a first portion that supports end portions of both sides of the rotor body 10 and a second support ring 62 as a second portion that supports the rotation shaft 3.

The first support ring 61 supports an external circumference of an end portion of both sides of the rotor body 10. The second support ring 62 forms the axial bore 53 and supports an end portion of the rotor coil 1.

The end coil cover 50 integrally connects the first and second support rings 61 and 62, and further includes ribs 63 that radially partition the plurality of connection passages 51.

In the foregoing description, the ribs 63 are radially connected to the second support ring 62 and are formed to be two-dimensionally connected to the second support ring 62 to correspond to an end portion of the rotor coil 1.

Hereinafter, operation of the rotor 100 of a wound rotor driving motor according to an exemplary embodiment of the present invention having the foregoing configuration will be described in detail with reference to the drawings.

First, in an exemplary embodiment of the present invention, when a current is applied to a stator coil of the stator and the rotor coil 1 of the rotor body 10, the rotor body 10 rotates by a magnetic action occurring between the stator and the rotor body 10. In this case, a copper loss occurs by resistance of the rotor coil 1, and thus heat occurs in the rotor coil 1.

In such a process, in the exemplary embodiment of the present invention, as the rotor body 10 rotates, the end coil cover 50 that is mounted at both sides of an axial direction of the rotor body 10 also rotates.

Here, in the exemplary embodiment of the present invention, in the rotor body 10, the air movement passage 31 is formed in an axial direction, and because a plurality of connection passages 51 that are connected to the air movement passage 31 are formed in the end coil cover 50, external air moves in an axial direction of the rotor body 10 along the air movement passage 31 through the connection passage 51.

In this case, external air as cooling air is injected into the air movement passage 31 of the rotor body 10 through the connection passage 51 of the end coil cover 50 that is located at one side of the rotor body 10, moves along the air movement passage 31, and is discharged through the connection passage 51 of the end coil cover 50 that is located at another side of the rotor body 10.

In particular, external air is injected into the air movement passage 31 of the rotor body 10 through the connection passage 51 of the end coil cover 50 that is located at both sides of the rotor body 10, and may be moved in both directions in an axial direction through the air movement passage 31.

Therefore, in the exemplary embodiment of the present invention, by moving external air to the air movement passage 31 of the rotor body 10 through the connection passage 51 of the end coil cover 50, heat occurring in the rotor coil 1 is discharged to the outside and the rotor coil 1 may be quickly cooled.

As described above, according to the rotor 100 of the wound rotor driving motor of the exemplary embodiment of the present invention, by forming the connection passage 51 that is connected to the air movement passage 31 of the rotor body 10 in the end coil cover 50 of both sides of the rotor body 10, external air is moved in an axial direction of the rotor body 10 as an open structure by utilizing a non-molding method of connecting the end coil cover 50 to the rotor body 10, and heat occurring in the rotor coil 1 may be efficiently discharged.

Thereby, in the exemplary embodiment of the present invention, a copper loss by resistance of the rotor coil 1 can be reduced, and thus efficiency of a drive motor can be increased, fuel consumption of an environmentally friendly vehicle can be enhanced, and durability of the drive motor can be improved.

Further, in the exemplary embodiment of the present invention, as in the conventional art, because the rotor coil 1 can be cooled through external air in an open structure by utilizing a non-molding method that removes a resin that is molded within the end coil cover, production cost can be reduced according to removal of the molding resin, and cooling performance of the rotor can be further enhanced with direct cooling of external air to the rotor coil 1.

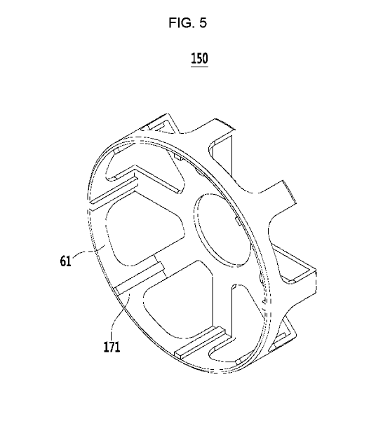

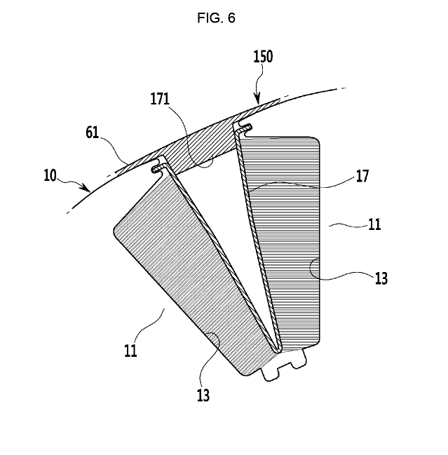

FIG. 5 is a perspective view illustrating an exemplary variation of an end coil cover that is applied to a rotor of a wound rotor driving motor according to an exemplary embodiment of the present invention, and FIG. 6 is a partial cross-section view illustrating an exemplary variation of an end coil cover that is applied to a rotor of a wound rotor driving motor according to an exemplary embodiment of the present invention.

Referring to FIGS. 5 and 6, an exemplary variation of an end coil cover 150 according to the exemplary embodiment of the present invention may remove a separate wedge plate for fixing a wedge 17 in an axial direction of a rotor body 10 and integrally form a wedge fixing portion 171 that is coupled to the wedge 17.

For example, the wedge fixing portion 171 is integrally formed at an inner circumference surface of the end coil cover 150, i.e., a support surface that supports an external circumference of an end portion of both sides of the rotor body 10, to correspond to each of slots 13 between rotor teeth 11.

The wedge fixing portion 171 is formed to integrally protrude at a support surface of the first support ring 61 in the end coil cover 150. The wedge fixing portion 171 is protruded in a quadrangular plate form, and may be insertion coupled to both end portions of the wedge 17 at both end sides of the rotor body 10.

That is, when coupling the end coil cover 150 to each of end portions of both sides of the rotor body 10, the wedge fixing portion 171 may be inserted and coupled to both end portions of the wedge 17 between the rotor teeth 11.

Therefore, in the exemplary embodiment of the present invention, because the wedge fixing portion 171 is integrally formed in the end coil cover 150, a separate wedge plate for fixing the wedge 17 in an axial direction of the rotor body 10 may be removed. Accordingly, in the exemplary embodiment of the present invention, the entire number of components of a drive motor can be reduced and thus production cost of the drive motor can be reduced.

Further, in the exemplary embodiment of the present invention, while coupling the end coil cover 150 to end portions of both sides of the rotor body 10, the wedge fixing portion 171 may be coupled to the wedge 17 and thus an assembly process of an entire drive motor can be simplified.

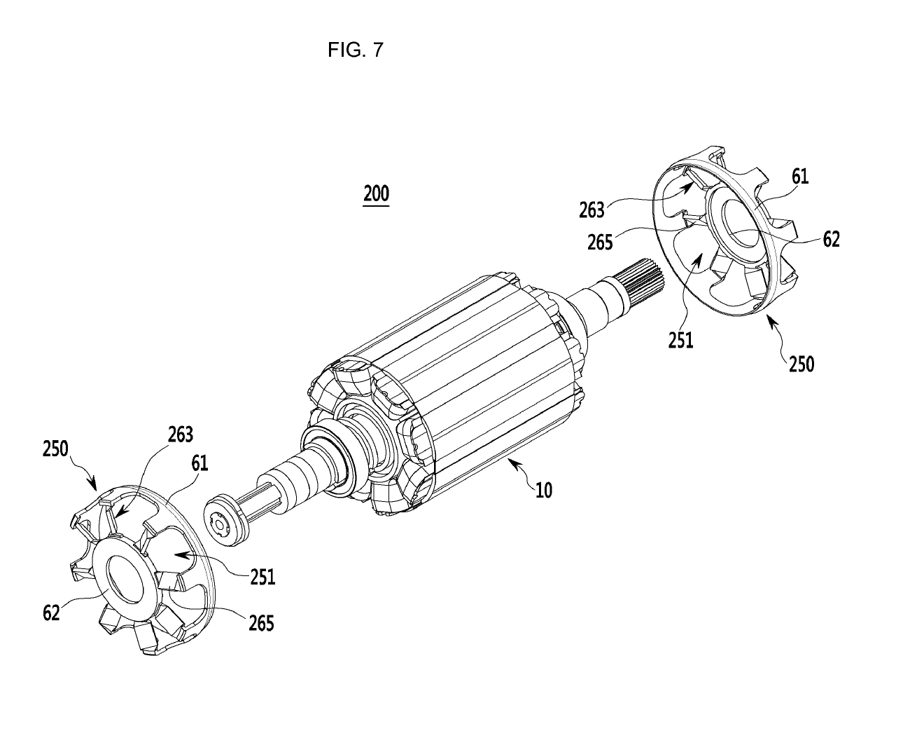

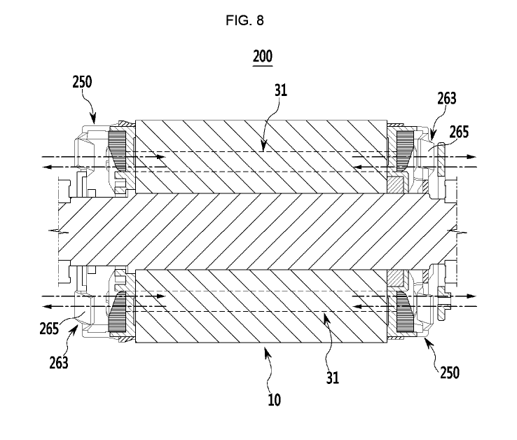

FIG. 7 is a partially exploded perspective view illustrating a rotor of a wound rotor driving motor according to another exemplary embodiment of the present invention, and FIG. 8 is a side cross-sectional view illustrating the rotor of the wound rotor driving motor of FIG. 7.

In FIGS. 7 and 8, reference numerals of the foregoing exemplary embodiment are given to constituent elements identical to or corresponding to those of the foregoing exemplary embodiment.

Referring to FIGS. 7 and 8, a rotor 200 of a WRSM according to another exemplary embodiment of the present invention may form an end coil cover 250 having ribs 263 that form a connection passage 251 as a twist blade 265 of a pan shape while having a structure of the foregoing exemplary embodiment as a basic structure.

In the embodiment of FIGS. 7-8, a configuration of a rotor body 10 and a coupling structure to the end coil cover 250 of the rotor body 10 are the same as those of the foregoing exemplary embodiment, and thus a detailed description thereof will be omitted.

In the end coil cover 250, the ribs 263 integrally connect first and second support rings 61 and 62 and radially partition a plurality of connection passages 251 that are connected to an air movement passage 31 of the rotor body 10, and in each end coil cover 250, the twist blade 265 of a pan shape that is twisted in one direction may be provided.

Here, the twist blade 265 of the end coil cover 250 that is located at an end portion of one side of the rotor body 10 and the twist blade 265 of the end coil cover 250 that is located at an end portion of another side of the rotor body 10 may be formed in pan shapes that are twisted in opposite directions. In particular, the end coil covers 250 that are mounted in each of end portions of both sides of the rotor body 10 form the twist blades 265 that have opposite twist directions.

When the end coil cover 250 rotates together with the rotor body 10, the twist blade 265 of the end coil cover 250 performs a function of injecting external air into the connection passage 251 and moving the external air through the air movement passage 31 of the rotor body 10.

Therefore, according to a rotor 200 of the wound rotor driving motor of FIG. 7 having the foregoing configuration, when the end coil cover 250 rotates together with the rotor body 10, in an end portion of one side of the rotor body 10, the twist blade 265 of the end coil cover 250 injects external air into the air movement passage 31 of the rotor body 10 through the connection passage 251.

In an end portion of another side of the rotor body 10, the twist blade 265 of the end coil cover 250 injects external air into the air movement passage 31 of the rotor body 10 through the connection passage 251.

In an end portion of one side of the rotor body 10, the twist blade 265 of the end coil cover 250 may inject external air in another side direction from one side of the air movement passage 31 through the connection passage 251. In an end portion of another side of the rotor body 10, the twist blade 265 of the end coil cover 250 may inject in one side direction from another side of the air movement passage 31 through the connection passage 251.

Accordingly, external air moves in an axial direction along the air movement passage 31 of the rotor body 10 through the connection passage 251 of the end coil cover 250, moves from an end portion of one side of the rotor body 10 to an end portion of another side and from an end portion of another side of the rotor body 10 to the end portion side of one side, and may be discharged through the connection passage 251.

In particular, external air is injected into the air movement passage 31 of the rotor body 10 through the connection passage 251 of the end coil cover 250 that is located at both sides of the rotor body 10 and may be moved in an opposite direction in an axial direction through the air movement passage 31.

Thereby, in an exemplary embodiment of the present invention, because external air may be moved through the air movement passage 31 of the rotor body 10 with an air blowing method through the twist blade 265 of the end coil cover 250, cooling performance of a rotor coil 1 can be further maximized

The remaining configurations and operations of the rotor 200 of the wound rotor driving motor according to the exemplary embodiment of the present invention are the same as those of the foregoing exemplary embodiments, and thus a detailed description thereof will be omitted.

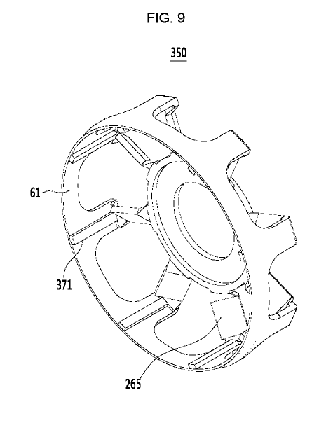

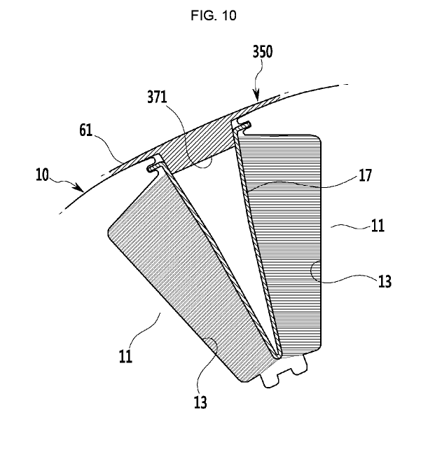

FIG. 9 is a perspective view illustrating an exemplary variation of an end coil cover that is applied to the rotor of the wound rotor driving motor of FIG. 7, and FIG. 10 is a partial cross-section view illustrating an exemplary variation of an end coil cover that is applied to the rotor of the wound rotor driving motor of FIG. 7.

Referring to FIGS. 9 and 10, an exemplary variation of an end coil cover 350 omits a separate wedge plate for fixing a wedge 17 in an axial direction of a rotor body 10 while having a twist blade 265, and may integrally form a wedge fixing portion 371 that is coupled to the wedge 17.

For example, the wedge fixing portion 371 is integrally formed at an inner circumference surface of the end coil cover 350, i.e., a support surface that supports an external circumference of an end portion of both sides of the rotor body 10, to correspond to each of the slots 13 between the rotor teeth 11.

The wedge fixing portion 371 is formed to integrally protrude at a support surface of a first support ring 61 in the end coil cover 350. The wedge fixing portion 371 is protruded in a quadrangular plate form, and may be insertion coupled to both end portions of the wedge 17 at both end sides of the rotor body 10.

In particular, when coupling the end coil cover 350 to each of end portions of both sides of the rotor body 10, the wedge fixing portion 371 may be inserted and coupled to both end portions of the wedge 17 between the rotor teeth 11.

The remaining configurations and operations of the end coil cover 350 according to the present exemplary variation are the same as those of the foregoing exemplary embodiments, and thus a detailed description thereof will be omitted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rotor of a wound rotor driving motor, the rotor comprising:
a rotor body that is rotatably installed at a predetermined air gap at an inside of a stator and in which a rotor coil is wound in a plurality of rotor teeth; and
an end coil cover that is mounted at each of both sides of an axial direction of the rotor body in order to prevent the rotor coil from separating,
wherein the rotor body forms a plurality of air movement passages that are open to the outside in an axial direction therein, and
the end coil cover forms a plurality of connection passages that are connected to the air movement passage.

2. The rotor of claim 1, wherein the rotor body is formed in an open structure by utilizing a non-molding method of connecting the end coil cover.

3. The rotor of claim 1, wherein the air movement passage is formed between rotor teeth in which the rotor coil is wound in the rotor body.

4. The rotor of claim 1, wherein the end coil cover comprises a plurality of ribs that radially partition the plurality of connection passages.

5. The rotor of claim 4, wherein the ribs are provided as a twist blade that is twisted in a pan shape.

6. The rotor of claim 5, wherein the twist blade has opposite twist directions at both sides of the axial direction of the rotor body.

7. The rotor of claim 5, wherein the end coil cover is coupled to each of both sides of the rotor body and is coupled to a wedge that supports the rotor coil between rotor teeth of the rotor body.

8. The rotor of claim 7, wherein the end coil cover integrally forms a wedge fixing portion that is coupled to the wedge.

9. The rotor of claim 1, wherein the end coil cover comprises.
a first support ring that supports external circumferences of both sides of the rotor body;
a second support ring that supports a rotation shaft of a central portion of the rotor body; and
ribs that integrally connect the first and second support rings and that radially partition the plurality of connection passages.

10. The rotor of claim 9, wherein the ribs are provided as a twist blade of a pan shape.

11. The rotor of claim 10, wherein the twist blade has opposite twist directions at both sides of the axial direction of the rotor body.

12. The rotor of claim 10, wherein the rotor body comprises a wedge that is installed between rotor teeth and that supports the rotor coil, and
a wedge fixing portion that is coupled to the wedge is integrally formed at a support surface of the first support ring.
